(19) United States
(12) Patent Application Publication
(10) Pub. No.: US 2023/0005457 A1
(43) Pub. Date: Jan. 5, 2023

(54) SYSTEM FOR GENERATING A SIGNAL BASED ON A TOUCH COMMAND AND ON AN OPTICAL COMMAND

(71) Applicant: EMBODME, PARIS (FR)

(72) Inventors: Edgar HEMERY, PARIS (FR); Mathieu FROHLICH, VANVES (FR)

(21) Appl. No.: 17/778,256

(22) PCT Filed: Nov. 19, 2020
(86) PCT No.: PCT/EP2020/082767

§ 371 Date: May 19, 2022

(30) Foreign Application Priority Data
Nov. 20, 2019 (FR) FR1912935

(51) Int. Cl. G10H 1/00; H04N 5/33; H04N 13/271; H04N 13/204; G06F 3/041; G06F 3/01; G10H 1/055; G06F 3/045

(52) U.S. Cl. CPC G10H 1/0008; H04N 5/33; H04N 13/271; H04N 13/204; G06F 3/0414; G06F 3/017; G10H 1/0558; G06F 3/045; G10H 2220/161; G10H 2220/201; G10H 2220/455; G10H 2220/026; G10H 2210/155

(57) ABSTRACT

A system for generating a signal includes a touchpad including touch cells and a touch detection device for detecting the location and intensity of a pressure exerted on the touchpad; a first computer generating a first instruction based on the location and intensity of the pressure; an optical detection device for detecting a movement and/or a position, including optics for capturing images; a second computer for determining a motion parameter based on the captured images and for generating a second instruction based on the parameter; and a signal generator for producing a second signal based on the first instruction or on a first signal extracted from the first instruction, to which there is applied a special effect extracted from the second instruction; or on the second instruction or on a first signal extracted from the second instruction, to which there is applied a special effect extracted from the first instruction.

### FIELD OF THE INVENTION

The invention relates to a system for generating a signal, in particular a sound signal. The invention also relates to a method for generating a signal, especially a sound signal. In particular, the field of the invention relates to musical instruments having a touchpad for generating a sound setpoint. The field of the invention especially relates to systems capable of being coupled to different control interfaces.

### STATE OF THE ART

Electronic musical instruments provide the possibility of producing a wide range of sound sequences, especially by combining sounds produced with different special effects or parameters aimed at modulating or modifying a sound or sounds. However, the musician's ability to control and adjust all of these sounds is limited by the performance of the instrument and by limitations of the instrument interface. There is a need to extend control capabilities and thus interface capabilities of a musical instrument to allow exploration and operation of the instrument sound production.

A similar problem can be encountered in various fields when there is a need to generate a wide variety of signals and effects that can be applied to said signals from a human-controlled signal generator. This need results in the definition of a new control interface to control various parameters of said signal in real time by the user. For example, the field of lighting, the control of a robot or the control of an avatar in video games can be mentioned.

There is thus a real need to increase the interface means in order to increase the possibilities for the user to generate a wide variety of effects on signals based on an instrument or a signal generator.

Among the existing musical instruments providing enriched control devices, the solution described in document FR3008217 is especially known. This solution describes a detection module, such as a gyroscope, to modify the sounds produced by a musical instrument. The gyroscope is attached to the musical instrument or to the musician. However, one drawback of this system is that it involves attaching a detection module in addition to the musical instrument which is likely to introduce inaccuracy in the measurements or requires the equipment to be configured for each use. A second drawback is the compatibility of the musical instrument with the detection module. Indeed, it is necessary in this solution to pass through a computer and to use a software collecting the signals of the musical instrument on the one hand and the signals acquired by the detection module on the other hand in order to generate the output signal. The musician has to implement at least three elements: the instrument, the computer and the detection module and has to proceed to a configuration for each device.

The invention aims at providing a system for generating a signal that allows a first signal to be modified without the drawbacks of prior art.

### SUMMARY OF THE INVENTION

According to a first aspect, the invention relates to a system for generating a signal comprising:
a touchpad comprising a plurality of touch cells and a touch detection device for detecting the location and intensity of at least one pressure exerted on said touchpad;
a first calculator generating at least one first setpoint based on the location and intensity of said at least one pressure; and
an optical detection device for detecting a motion and/or a position comprising at least one optics for capturing images;
a second calculator for determining at least one motion parameter based on the captured images and for generating a second setpoint based on said at least one motion parameter.

One advantage is to allow two setpoints or signals to be combined to produce a single signal from two items of equipment providing different interaction modes with a user. Indeed, a first equipment makes it possible to take into account the touch and the press-in force of a finger within cells of a keyboard and the second equipment makes it possible to take into account an amplitude of gestures in space. An interest is that one of the generated setpoints is associated with a signal and the other generated setpoint allows effects to be produced for example to modulate the first signal. A single original signal can therefore be produced by means of the system of the invention. This combination of interactions makes it possible to provide a wide range of combinations of produced signals such as the production of sound signals. Finally, another advantage is to allow a significant freedom of uses of an instrument, such as a musical instrument, allowing each user to configure and appropriate this instrument.

In a first alternative embodiment, each of the first setpoints is associated with the production of a first signal and the system comprises a signal generator for producing a second signal based on the first setpoint or the first signal to which a special effect extracted from the second setpoint is applied.

In a second alternative embodiment, each of the second setpoints is associated with the production of a first signal and the system comprises a signal generator for producing a second signal based on the second setpoint or the first signal to which a special effect extracted from the first setpoint is applied.

In one embodiment, the first signal and the second signal are sound signals.

In one embodiment, each touch cell comprises a first layer comprising at least one force sensing resistor and comprises a second layer comprising a detection cell designed to detect a variation in the resistivity of the force sensing resistor.

In one embodiment, each detection cell comprises a printed circuit comprising at least a first portion and a second portion connected to each other by the force sensing resistor of the first layer.

In one embodiment, the motion parameter is determined based on the amplitude, speed and/or direction of the hand and/or a finger of the hand.

In one embodiment, the optical detection device for detecting a motion and/or a position comprises a stereo camera, preferably an infrared stereo camera and/or a depth camera.

One advantage is to enable a wide range of motions to be detected and gestures to be characterized finely to produce sound effects on a first generated signal.

In one embodiment, the first signal corresponds to or comprises a musical note.

In one embodiment, the system comprises a user interface for providing the second calculator with feedback data. The second calculator then includes a reinforcement learning algorithm configured to modify the mode of generation of the second setpoint based on the feedback data by iteration.

In one embodiment, said system is a musical instrument and the touchpad and optical detection device are integrated into a single case.

In one embodiment, the first calculator and the second calculator are integrated into said case.

In one embodiment, each touch cell includes a lighting source for producing a light signal when a pressure is applied to said touch cell.

In one embodiment, the signal generator is configured to produce the second signal as a third setpoint.

According to a second aspect, the invention relates to a method for generating a signal comprising:
acquiring the location and intensity of a pressure on a touchpad having a plurality of touch cells;
producing a first setpoint associated with the production of a first signal; and
acquiring at least one image by at least one optics; and
determining at least one motion parameter based on the acquired images;
generating a second setpoint based on the motion parameter.

The method also includes a step of generating a second signal based on:
the first setpoint or a first signal associated with the first setpoint to which a special effect extracted from the second setpoint is applied; or
the second setpoint or a first signal associated with the second setpoint to which a special effect extracted from the first setpoint is applied.

In one embodiment, the first signal and the second signal are sound signals.

In one embodiment, the first setpoint or the second setpoint is associated with a first signal.

In one embodiment, the motion parameter is also determined based on the amplitude, speed and/or direction of the hand and/or a finger of the hand.

In one embodiment, the first sound signal corresponds to a musical note.

In one embodiment, generating a second signal includes a step of generating a third setpoint associated with the second signal.

In one embodiment, determining the at least one motion parameter comprises detecting points of interest such as the finger tips, the center of mass, and/or a deflection point.

In one embodiment, the step of determining at least one motion parameter based on the acquired images comprises generating a depth map, said motion parameter also being determined depending on said depth map.

In one embodiment, said special effect comprises one or more of the elements listed below:
a reverberation,
an echo,
a distortion,
a sustain,
a wha-wha,
a vibrato,
a phase shift.

According to a third aspect, the invention relates to a system for generating a signal comprising hardware and/or software elements implementing the method according to the second aspect of the invention, especially hardware and/or software elements designed to implement the method according to the second aspect of the invention.

In one embodiment, the hardware means comprise:
a touchpad;
a touch detection device;
an optical detection device;
a first calculator;
a second calculator; and
a signal generator.

According to a fourth aspect, the invention relates to a computer program product downloadable from a communication network and/or recorded on a computer-readable and/or computer-executable data storage medium, comprising computing program code instructions for implementing the method according to the second aspect of the invention.

According to a fifth aspect, the invention relates to a computer-readable data storage medium, having recorded thereon a computer program comprising program code instructions for implementing the method according to the second aspect of the invention.

According to a sixth aspect, the invention relates to a system for generating a signal comprising:
a touchpad comprising a plurality of touch cells and a touch detection device for detecting the location and intensity of at least one pressure exerted on said touchpad;
a first calculator generating at least one first setpoint based on the location and intensity of said at least one pressure, each of the first setpoints being associated with the production of a first signal;
an optical detection device for detecting a motion and/or a position comprising at least one optics for capturing images; and
a second calculator for determining at least one motion parameter based on the captured images and for generating a second setpoint based on the at least one motion parameter; and
a signal generator for producing a second signal based on the first setpoint or the first signal to which a special effect extracted from the second setpoint is applied.

According to a sixth aspect, the invention relates to a system for generating a signal comprising:
a touchpad comprising a plurality of touch cells and a touch detection device for detecting the location and intensity of at least one pressure exerted on said touchpad;
an optical detection device for detecting a motion and/or a position comprising at least one optics for capturing images;
a first calculator generating a first setpoint based on the location and intensity of said at least one pressure;
a second calculator for determining at least one motion parameter based on the captured images and for generating at least one second setpoint based on said at least one motion parameter, each of the second setpoints being associated with the production of a first signal; and
a signal generator for producing a second signal based on the second setpoint or the first signal to which a special effect extracted from the first setpoint is applied.

According to an eighth aspect, the invention relates to a method for generating a signal comprising:
acquiring the location and intensity of a pressure on a touchpad having a plurality of touch cells;
producing a first setpoint associated with the production of a first signal;
acquiring at least one image by at least one optics;
determining at least one motion parameter based on the acquired images;
generating a second setpoint based on the motion parameter; and
generating a second signal based on the first setpoint or the first signal to which a special effect extracted from the second setpoint is applied.

### BRIEF DESCRIPTION OF THE FIGURES

Further characteristics and advantages of the invention will become apparent upon reading the following detailed description, with reference to the attached figures, which illustrate:

FIG. 1: a schematic view of a system according to one embodiment of the invention;

FIG. 2: a schematic view of a system according to one embodiment of the invention comprising a user interface for transmitting feedback data;

FIG. 3: a cross-sectional view of the touchpad according to one embodiment;

FIG. 4: a logic diagram of the method for generating a signal according to one embodiment of the invention;

FIG. 5: a logic diagram of the method for generating a signal according to one embodiment of the invention further comprising a user feedback step;

FIG. 6: a view of a case comprising the system according to one embodiment of the present invention;

FIG. 7A: a schematic view of a detection cell according to one embodiment of the invention;

FIG. 7B: a schematic view of a multiplexing circuit of the touch detection device according to one embodiment of the invention;

FIG. 7C: a schematic view of an electronic residual current reduction module according to one embodiment;

FIG. 8: a schematic view of a first layer of the touchpad according to one embodiment of the invention;

FIG. 9A FIG. 9B FIG. 9C FIG. 9D FIG. 9E FIG. 9F FIG. 9G FIG. 9H and FIG. 9I: a graphical representation of types of gestures detectable by the optical detection device according to one embodiment;

FIG. 10: a representation of an image of a hand in which each pixel is labeled so as to generate areas of interest of the hand;

FIG. 11: the representation of the image of a hand comprising points of interest.

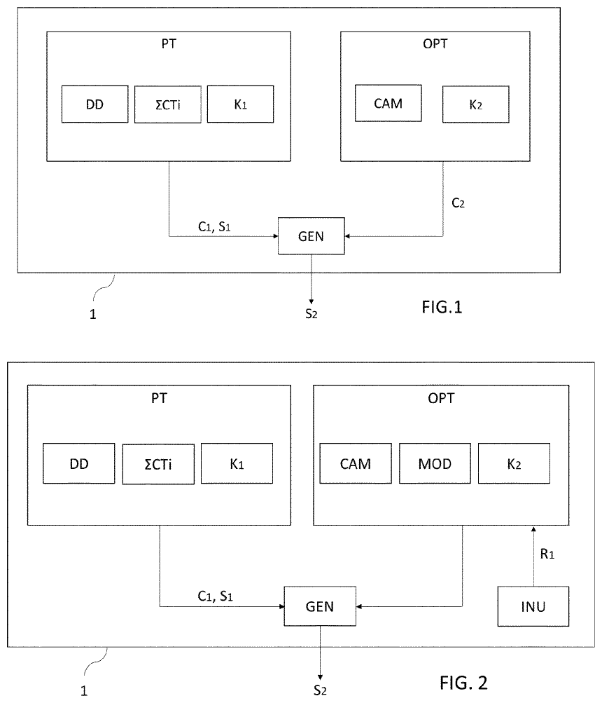

### DETAILED DESCRIPTION

The technical problem is solved by the invention, especially by an optical detection device for detecting a motion and/or a position for generating a special effect depending on the user's gestures. The special effect is intended to be applied to a first signal determined based on a touchpad PT.

The system is preferably a musical instrument. In the following, the system is especially described by the example of a musical instrument. The signal produced by the system is thus in this case a sound sequence. However, the present invention is not limited to a musical instrument. Indeed, the signal produced can be a light signal, a video signal or any other type of signal that can be produced by a signal generator and that can be modified by the application of a special effect such as a spatial or temporal filter, a predefined data processing, or any other digital or analog effect.

The description of the system describes the main components of said system, each alternative of the components described can be combined with an embodiment described in this description.

The system comprises, on the one hand, a touchpad PT for generating a first setpoint C₁ associated with the production of a first signal, and on the other hand, an optical detection device OPT for determining a motion parameter D₁ and generating a second setpoint C₂ associated with a special effect to be applied to the first signal.

Touchpad

The touchpad PT comprises a plurality of touch cells CT. Advantageously, the touchpad PT makes it possible to detect a pressure exerted on one or more touch cells. For this purpose, the touchpad PT comprises a touch detection device DD. The touch detection device DD advantageously makes it possible to determine, on the one hand, the location of the touch cell CT on which a pressure has been exerted and, on the other hand, the intensity of said exerted pressure.

The touchpad PT comprises a plurality of touch cells CT. Each touch cell CT comprises at least one force sensing resistor 31. Preferably, the first layer 3 comprises a plurality of force sensing resistors FSR 31. A force sensing resistor 31 is an electronic sensor whose resistance varies depending on the pressure applied to it.

Each touch cell CT includes at least one detection cell 41. The detection cell 41 is preferably arranged in contact with the force sensing resistor 31. The detection cell 41 is configured to respond to a change in the resistivity of the force sensing resistor 31.

Each force sensing resistor 31 is associated with a detection cell 41. In one embodiment, a force sensing resistor 31 may be included in multiple touch cells CT.

Detection Cells

The detection cell 41 preferably comprises a printed circuit 71. The circuit of the detection cell comprises an electrical input 74 and an electrical output 75.

The printed circuit 71 comprises a first portion 73 connected to an electrical input 74 and a second portion 72 connected to the electrical output 75. The first portion 73 and the second portion 72 of the printed circuit 71 are not in contact with each other: the printed circuit 71 is an open circuit.

The printed circuit 71 is in contact with a layer of force sensing resistor 31 of the first layer 3. The force sensing resistor 31 is in contact with the first portion 73 and with the second portion 72 of the printed circuit.

When no pressure is exerted on the force sensing resistor 31, the force sensing resistor is insulating between the first and second portions.

When a pressure is exerted on the touchpad PT, the force sensing resistor 31 is subjected to the pressure. The resistivity of the force sensing resistor 31 decreases as the pressure is increased. At a certain pressure, the force sensing resistor 31 conducts electricity between the first portion 73 and the second portion 72 of the printed circuit 71.

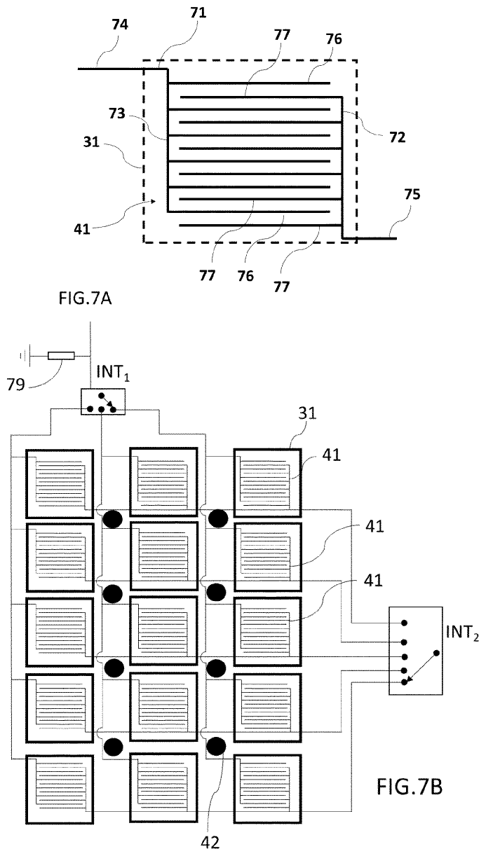

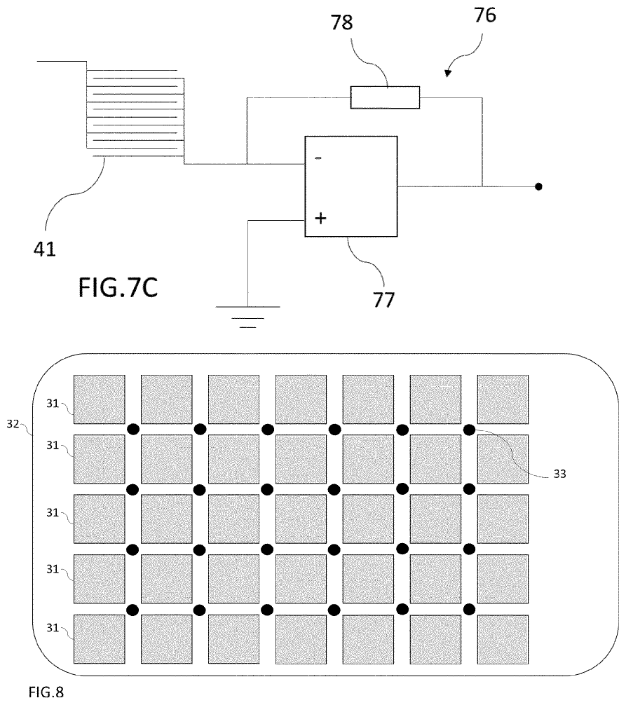

In one embodiment illustrated in FIG. 7A the first portion comprises a plurality of branched tracks 76. Preferably, the plurality of branched tracks comprises a plurality of substantially parallel tracks 76 that extend from a first main track of the first portion. The first main track extends from the electrical input 74. In this same embodiment, the second portion also comprises a second main track XX extending from the electrical output 75 and a plurality of branched tracks extending from said second main track.

Preferably, the branched tracks 77, 76 of the first and second portions alternately interlock with each other without contacting. The force sensing resistor 31 allows electrical contact to be made between each adjacent branched track when a pressure is exerted on said pressure sensor resistor.

This embodiment advantageously improves conductivity between the electrical input 74 and the electrical output 75 of the detection cell 41 when a pressure is applied to the force sensing resistor 31.

The overall conductivity of the printed circuit of the detection cell 41 between the input 74 and the output 75 of the printed circuit 71 increases when a pressure is exerted on the force sensing resistor 31.

The more significant the intensity of pressure exerted on the force sensing resistor 31, the more the resistivity of said force sensing resistor 31 decreases and thus the conductivity of the detection cell 41 increases. The conductivity of the detection cell 41 is therefore a function of the intensity of pressure exerted on the force sensing resistor 31.

In one embodiment, the length and/or width dimensions of the detection cell 41 are between 5 mm and 15 mm.

In one embodiment, the first portion and/or the second portion comprise a number of interlocking branched tracks between 5 and 15. Each branched track may extend over a length between 5 mm and 15 mm and/or a width between 0.05 mm and 1 mm. The gap between a branched track of the first portion 73 and the branched track of the adjacent second portion 72 is between 0.05 mm and 1 mm.

In one embodiment, the length of each branched track is between 3 mm and 20 mm. In one embodiment, the width of the overall shape of the circuit of the detection cell 41 is between 5 mm and 15 mm. The printed circuit is preferably made of copper, aluminum or most preferably gold.

First Layer

In one embodiment, the touchpad PT may comprise a first layer 3 intended to be superimposed on a second layer 4. The first layer 3 comprises at least one force sensing resistor 31. The force sensing resistor 31 preferably comprises a conductive material whose resistivity property varies depending on the pressure that is exerted on said material. Said material preferably comprises a mixture of conductive and insulating particles in a matrix. Said matrix is preferably a polymer matrix. When a pressure is exerted, the conductive fillers contact each other, modifying the resistivity properties of the material. In one embodiment not represented, the first layer 3 comprises a sheet of force sensing resistor 31.

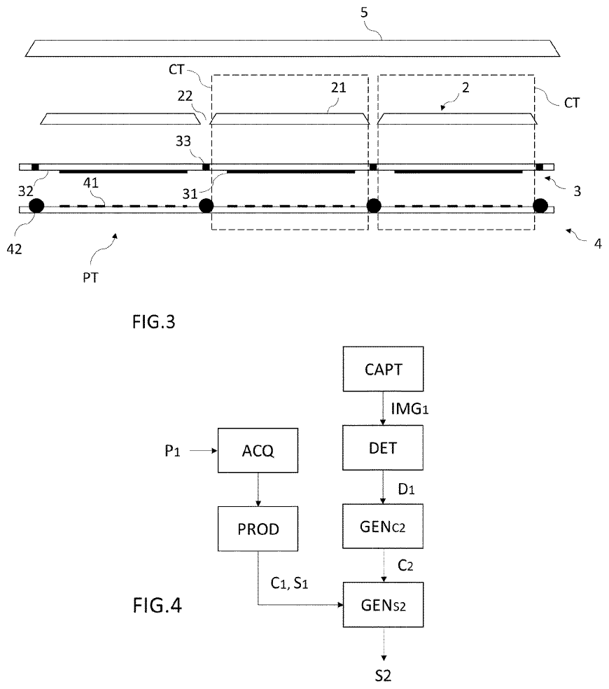

According to one alternative embodiment illustrated in FIG. 3, the first layer 3 comprises a support sheet 32. The support sheet 32 is preferably transparent. The support sheet 32 is preferably deformable. The force sensing resistor(s) are arranged on said support sheet 32.

Preferably, the force sensing resistor(s) 31 are printed on said support sheet 32 of the first layer 3. The force sensing resistor 31 is thus obtained by printing an ink on the deformable sheet. Said ink comprises said material whose resistivity property varies depending on the pressure that is exerted on said material.

The deformability of the support sheet 32 advantageously allows the pressure forces exerted on the touchpad PT to be transmitted. The deformability of the support sheet 32 advantageously also allows easier mounting of the touchpad PT. A transparent support sheet 32 advantageously allows display means visible to the user to be integrated below the touchpad PT through the first layer 3.

The support sheet 32 thus advantageously makes it possible to serve as a mechanical support for the ink FSR. It also reduces the amount of ink to be used compared to a sheet of force sensing resistor 31 by reducing the thickness required and by allowing regions of the first layer 3 comprising a force sensing resistor 31 to be selected.

In a preferred embodiment illustrated in FIG. 8, the support sheet 32 comprises a force sensing resistor matrix. Most preferably, the force sensing resistor matrix is arranged on a first surface of the support sheet 32.

Press-in layer and contact layer.

The touchpad PT may include a press-in layer 2. The press-in layer 2 may be intended to receive pressure from the user. The press-in layer 2 allows the pressure exerted by the user to be transmitted to the force sensing resistor 31. The press-in layer 2 is preferably made of a deformable material, most preferably a plastic material. As illustrated in FIG. 3, the press-in layer 2 may be divided into a plurality of keys 21, preferably into a matrix of keys 21.

The first layer 3 and the press-in layer 2 are arranged such that each key 21 is located facing a force sensing resistor 31.

In one embodiment, the press-in layer 2 is superimposed on the first layer 3. The press-in layer 2 is preferably arranged facing the second surface of the support sheet 32 of the first layer 3. The second surface of the support sheet 32 is the face opposite the first surface on which the force sensing resistors are arranged.

Advantageously, the press-in layer 2 serves as a protective layer for the first layer 3. Advantageously, the press-in layer 2 makes it possible to create a first filter of the detection cell 41. Below a certain pressure, the strains are damped by the press-in layer 2 and will not be transmitted to the first layer 3. Advantageously, the press-in layer 2 reduces the risk of detecting an unintentional press on the touchpad PT.

In one embodiment, the touchpad comprises a press-in layer and a contact layer 5. The contact layer 5 is disposed above the press-in layer 2 and is intended to be touched by the user to exert a pressure on the press-in layer 2.

According to one example, the press-in layer is made of translucent plastic to allow an amount of light from the touchpad PT to pass through. A user may have the sensation of a key being lit when a pressure is exerted on the key.

Second Layer

The touchpad PT further comprises a touch detection device DD. The device comprises a second layer 4. The second layer 4 is arranged in contact with the force sensing resistor 31 of the first layer 3.

The second layer 4 comprises a plurality of detection cells 41. Each detection cell 41 is in contact with a force sensing resistor 31. Each detection cell 41 is positioned in contact with a force sensing resistor 31. Each detection cell 41 is designed to respond to a variation of the force sensing resistor 31. As illustrated in FIG. 3, each touch cell CT thus comprises at least one detection cell 41 and one force sensing resistor 31.

Light Sources

In one embodiment not represented, the system comprises a plurality of light sources. The light sources are designed to emit light when a pressure is exerted by the user on a touch cell CT adjacent to said light source. This way, the user advantageously receives, upon pressing a touch cell, a light response from said touch area being pressed.

In one embodiment, each light source is arranged between two touch cells. As illustrated in FIG. 3, each light source may be arranged on the second layer between at least two detection cells. As illustrated in FIG. 7B, the light sources 42 may be disposed between four detection cells 41 disposed in a square.

As illustrated in FIG. 8, the first layer 3 may include bores 33. The bores 33 are arranged facing the light source 42 so as to pass light from said light source 42 through said bore 33.

As illustrated in FIG. 3, the press-in layer 2 comprises light wells 22. The light wells 22 may comprise a hole that increases in cross-sectional area away from the light source 42. The light wells 22 are arranged facing the light source and optionally facing the bores 33 of the first layer 3.

The light wells allow light to be diffused more evenly through the contact layer 5.

The touchpad is disposed to allow the light source to emit light outwardly from the touchpad PT through the second layer 4, the first layer 3, and the press-in layer 2. The light source may comprise a light emitting diode.

In one embodiment, the light source of the touch cell CT is designed to emit light when a pressure is exerted on the touchpad by the user. According to one example, a dimmer is associated with the light to generate an emitted power proportional to the pressure exerted. For this purpose, the dimmer can be driven by a setpoint generated based on the pressure exerted. The latter can be measured indirectly by the resistivity of the force sensor.

Detection Device

The touchpad PT includes a touch detection device DD.

The touch detection device DD includes hardware and/or software means for detecting a variation in the resistivity of each detection cell 41. The touch detection device DD generates information comprising the location of the detection cell 41 that has undergone a variation in resistivity and the intensity of said variation. The cell location may then be coupled to a sound library comprising predefined location information.

In one embodiment, the touch detection device DD includes a multiplexing circuit. The multiplexing circuit is connected to the detection cells 41 by a matrix of rows and columns. The multiplexing circuit connects each detection cell 41 to a current source. Voltage, current, or resistivity can be measured on each circuit formed by a detection cell and a conductor organized in a row and column of the matrix.

The multiplexing circuit is more particularly described below with reference to FIG. 7B.

In one embodiment, the input 74 of the printed circuit 71 of each detection cell 41 is connected to a column of the multiplexing circuit and the output 75 of the printed circuit 71 of each detection cell 41 is connected to a row of the multiplexing circuit or vice versa.

This embodiment advantageously allows, by scanning the rows and columns of the multiplexing circuit, the resistivity of each detection cell 41 to be measured one after the other. The scanning frequency can be configured so that the entirety of the columns and rows is probed when a key is being pressed.

Preferably, the second layer 4 comprises a printed circuit comprising the detection cells 41 and/or the multiplexing circuit.

The multiplexing circuit comprises a first switch INT1. The first switch INT1 is connected in series with a current generator. The first switch INT1 includes an input terminal. The input terminal of the first switch INT1 is connected in series with a power supply. The first switch INT1 comprises a plurality of output terminals. Each output terminal is connected in series with a column of the multiplexing circuit. The first switch INT1 is designed to power each column of the multiplexing circuit by scanning.

The multiplexing circuit comprises a second switch INT2. The second switch INT2 comprises an output terminal connected to a voltage measuring instrument.

The second switch INT2 comprises a plurality of input terminals. Each input terminal is connected to a row of the multiplexing circuit. The second switch INT2 is designed to connect each row of the multiplexing circuit to the voltage measuring instrument by scanning.

The multiplexing circuit allows each row and each column to be powered independently one by one by scanning depending on the connection of the first and second switches INT2. The multiplexing circuit comprises means for measuring a voltage between the first switch INT1 and the second switch INT2.

The multiplexing circuit thus enables each detection cell 41 to be powered one by one depending on the connection of the first and second switches INT2. The voltage and/or resistivity of each detection cell 41 can thus be measured. A modification in voltage and/or resistivity then indicates the presence of a pressure exerted on said touch cell CT of said detection cell 41.

The touch detection device DD preferably comprises a memory. The memory records the position of the first switch INT1 and the position of the second switch INT2 when a variation in resistivity is detected. Preferably, the memory also records the intensity of the resistivity variation. A calculator associated with the memory is then configured to generate position information based on the position of the first and second switches INT1, INT2.

The touch detection device DD is thus advantageously able to determine the location of a pressure exerted on the touchpad PT.

Position information can thus be generated depending on the position of the two switches when a change in resistivity is detected. Pressure intensity information may also be generated depending on the measured or calculated resistivity value.

In one embodiment, the multiplexing circuitry includes residual current reduction modules. The residual current could indeed increase the risk of false positive detection.

The residual current reduction module may comprise a voltage divider bridge.

In one embodiment, the residual current reduction module includes a first resistor 79. The first resistor 79 is arranged to be connected to the electrical input 74 of each detection cell 41. Preferably, the first resistor 79 is arranged upstream of the first switch INT1 as shown in FIG. 7B. In one embodiment, the first resistor 79 is connected in parallel to the first switch INT1 and/or is connected in series to ground.

In one embodiment illustrated in FIG. 7C, the residual current reduction module includes a feedback loop 76. Advantageously, the feedback loop 76 allows the residual voltage that may be present in the circuit to be eliminated.

According to one example, the feedback loop includes an operational amplifier 77. The operational amplifier 77 is preferably connected in series with a row of the multiplexing circuit. In one embodiment, each row of the multiplexing circuit includes a feedback loop 76 in series.

The feedback loop 76 includes a second resistor 78. The second resistor 78 is shunt connected to the operational amplifier 76. Said second resistor 78 is connected to the negative input terminal and the output terminal of the operational amplifier 77. The positive input terminal of the operational amplifier is preferably connected to ground.

Preferably, the impedance of the second resistor 78 is greater than the impedance of the first resistor 79.

Advantageously, the feedback loop allows the circuit impedance to be increased so as to make the circuit impedance caused by the first resistor 79 negligible.

The current reduction module thus makes it possible to reduce the residual current without influencing the measured voltage values.

This arrangement advantageously reduces the residual current present in the circuit which could lead to false positive detection.

In one alternative embodiment, the feedback loops 76 may be included on each column of the multiplexing circuit.

Alternatives to the Touchpad

In one alternative embodiment, the touchpad PT may be replaced by an electronic control pad for generating a first setpoint C₁ associated with the production of a first signal S₁. The electronic control pad may comprise an electronic piano, a synthesizer or a synthesizer controller.

Optical Detection Device

The system according to the present invention comprises an optical detection device OPT for detecting a motion and/or a position. This device is compatible with all alternatives of the touch detection device previously disclosed.

The optical detection device OPT is designed to capture images of a user, in particular of the hands, forearms and possibly upper arms, or even the torso. The optical detection device OPT allows the detection of a motion and/or the detection of a position of at least one part of the user's body. Preferably, the optical detection device OPT allows the detection of a motion or a position of at least one hand of a user.

Advantageously, a user can thus use a first hand to exert one or more pressures on the touchpad PT and use the second hand with the optical detection device OPT.

In one alternative embodiment, the optical detection device OPT allows images of a second user to be captured. Said second user is a person other than the person exerting a pressure on the touchpad PT. In this case, the system is then used simultaneously by two users, one for the touchpad PT and one for the optical detection device OPT.

In another embodiment, the optical detection device OPT and the touchpad PT are separate and connected wirelessly, for example through the internet network.

The optical detection device OPT comprises at least one optics CAM for capturing images of the user.

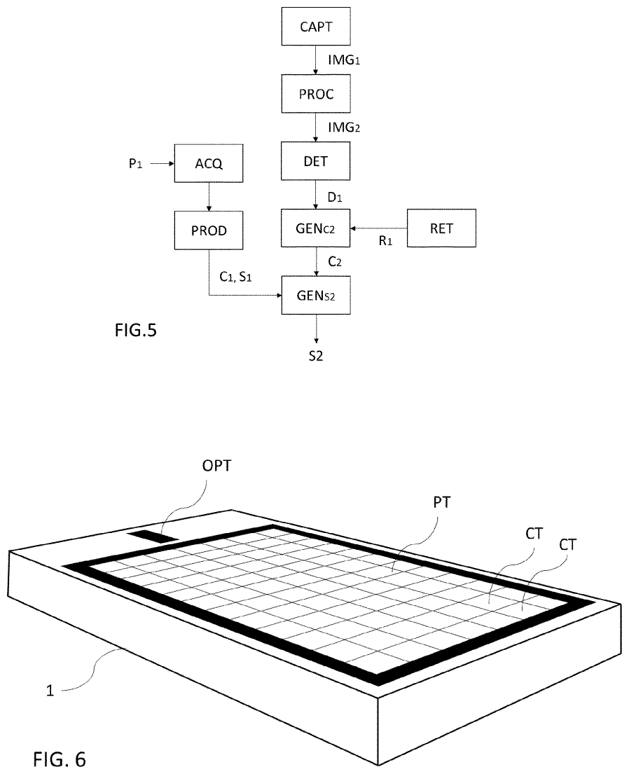

In one embodiment illustrated in FIG. 6, the touchpad PT, the optical detection device OPT are included in a single case. According to one embodiment, the touchpad PT and the optics CAM are integrated on the same surface of the case 1. In this case, the optics CAM is for example arranged to be adjacent to the touchpad PT. This arrangement advantageously makes it easier to sense images from a user's hand exerting a pressure on the touchpad PT with his other hand. The second hand of the user is then closer to the field of capture of the optics CAM.

Optics

The optics CAM may include a camera, a stereo camera system, and/or a depth camera. The stereo camera system generally comprises at least two cameras whose relative position is known. Together, the two acquisitions are used to determine a depth map. A depth camera is generally equipped with an emitter, for example a beam of light in the infrared range, and makes it possible to obtain time of flight information by measuring the reflected signal. The information is then used to determine a depth data.

The optics CAM can be designed to capture images in the visible wavelengths. The optics CAM can be designed to capture images in the infrared wavelengths. Preferably, the optics CAM comprises an infrared camera or an infrared stereo camera system.

In one alternative embodiment not represented, the optics CAM is not integrated into the case.

In one embodiment, the system of the invention includes multiple optics CAM. A first optics CAM may be arranged to sense images of at least one first part of the user's body and a second optics CAM may be arranged to sense images of at least one second part of the user's body.

In a first example, the first optics CAM is arranged to sense images of a hand of the user and the second optics CAM is arranged to sense images of the upper part of the user.

In a second example, the second optics CAM may be arranged to sense images of a body part of a second user.

Method for Generating a Signal

In one embodiment, the present invention comprises hardware means and/or software means coupled to the touchpad PT for implementing a method for generating a signal S₁.

In one embodiment, the system according to the present invention comprises a first calculator K₁. The first calculator K₁ comprises software means for generating at least one first setpoint C₁. The first setpoint C₁ is associated with the production of a first signal S₁. Each first setpoint C₁ is generated based on the location and intensity of a pressure exerted on the touchpad PT. This setpoint can be used to generate said first signal S₁. One advantage is that when the musical instrument is not integrated into the system of the invention, the setpoint can be transferred to the input of the musical instrument for the latter to generate a sound. When the instrument is integrated into the system, the setpoint can be directly operated by the system to produce the signal S₁.

Calculator K₁

The first calculator K₁ is connected to the touch detection device DD of the touchpad PT. The first calculator K₁ may be connected to the memory module of the touch detection device DD.

In one embodiment, the first calculator K₁ comprises software means for implementing the following steps of:
Receiving information comprising at least the location of a pressure exerted on the touchpad PT;
Associating said location with a first signal S₁, for example from a library or a database storing prerecorded data; and
Generating a first setpoint C₁ associated with the production of said first signal S₁.

If the instrument is not integrated into the system, one interest is to use libraries on demand, that is pre-established according to the instruments. The setpoint can be easily associated with a sound library of an instrument. Thus, making an instrument compatible with the touchpad can be easily performed.

The information transmitted by the touch detection device DD may comprise the following information:
The location of the at least one pressure exerted on the touchpad PT;
The intensity of the at least one pressure exerted on the touchpad PT.

The first setpoint C₁ is generated based on the information received by the touch detection device DD. The first setpoint C₁ is generated based on the location and/or intensity of the at least one pressure exerted on the touchpad PT.

The touch detection device DD can detect at least two pressures exerted on the touchpad PT at two different locations. The touch detection device DD then generates information including the location of each pressure and the intensity associated with each pressure.

In one embodiment, the first calculator K₁ generates as many first setpoints C₁ as there are pressures detected by the touch detection device DD. Each setpoint is associated with the production of a signal based on the location and intensity of a pressure.

Preferably, the first signal S₁ associated with the first setpoint C₁ generated by the first calculator K₁ is a sound signal. In this embodiment, each touch cell CT can be associated, for example, with a musical note. The frequency of the first sound signal S₁ associated with the first setpoint C₁ depends on the location of the pressure exerted on the touchpad PT. This can be configured in a prior step to prepare the touchpad for a specific use.

In one embodiment, the frequency of a sound signal to be produced is associated with several simultaneous notes, for example when several simultaneous pressures are exerted on the touchpad PT.

The first setpoint C₁ preferably comprises a MIDI (Musical Instrument Digital Interface) control message. The MIDI protocol is a communication protocol and a file format dedicated to music. The MIDI control can comprise information about the frequency of a sound signal to be produced. The frequency corresponds to the note associated with the sound signal to be produced.

Preferably, the information of the frequency of a sound signal to be produced is determined based on the at least one location of the pressure exerted on the touchpad PT.

The MIDI control may include information on a particular timbre to be applied to the sound signal to be produced. The timbre makes it possible, for example, to reproduce the same note produced with two different instruments. The timbre may be determined depending on the location of the pressure exerted on the touchpad PT.

The MIDI control may include information about the velocity associated with the note. Preferably, the velocity of the note is determined based on the intensity of the pressure exerted on the touchpad PT.

The MIDI control of the first setpoint C₁ may comprise information for triggering and/or stopping the production of the first sound signal S₁.

Preferably, the MIDI control message may be produced during the entire time that the at least one pressure is exerted on the touchpad PT.

Calculator K₂

The system according to the present invention includes a second calculator K₂. The second calculator K₂ includes software means for generating a second setpoint C₂. The second setpoint C₂ is associated with the production of at least one special effect.

The second calculator K₂ comprises software means for implementing the following steps of:
Receiving images captured by the optical detection device OPT;
Determining at least one motion parameter D1 based on the captured images; and
Generating a second setpoint C₂ based on said motion parameter D1.

In one embodiment, the second calculator K₂ and the first calculator K₁ are the same calculator.

Learning-Based Artificial Intelligence Algorithm

In one embodiment, the second calculator K₂ comprises a supervised learning agent. The supervised learning agent may comprise a learning-based artificial intelligence algorithm.

The supervised learning agent is trained on examples of gestures performed by different individuals. According to an example of embodiment, the artificial intelligence algorithm allows, from a trained neural network, a gesture to be classified according to a classifier. The detection of the gesture and its class then allows a special effect to be associated to it.

In one embodiment, the system according to the invention comprises a display means. The display means makes it possible to represent data relating to the motion parameter D1.

Reinforcement Learning Agent

In one embodiment, the second calculator K₂ comprises a reinforcement learning agent. Advantageously, the reinforcement agent allows a positive or negative feedback RET from the user to the agent regarding its current or past action to be performed iteratively.

The user can thus, when generating the second signal S2 by the signal generator, give a positive or negative comment on the special effect applied to the first signal S₁. The reinforcement learning agent thus continues to associate a motion parameter D1 with a special effect by discovering which associations are most positively or negatively rewarded. The reinforcement learning agent can thus modify the method for associating a motion parameter D1 with a special effect to aim at a method whose associations are most rewarded.

The step of generating GEN_{C2} a second setpoint C₂ and/or the step of determining DET a motion parameter D₁ may thus include a reinforcement learning agent.

Advantageously, reinforcement learning agents allow progressive learning according to the user's feedback. The reinforcement learning agent thus allows the second calculator K₂ to generate second setpoints comprising special effects that converge towards effects that are more liked by the user.

In this embodiment, the system includes a user interface INU. The user interface INU enables the second calculator K₂ to be provided with feedback data R1.

The second calculator K₂ is configured to modify the mode of generation of the second setpoint C₂ based on the images received depending on the feedback data by iteration.

Generation of a Setpoint C₂

The second calculator K₂ comprises software means for implementing a step of generating a second setpoint C₂ based on said motion parameter D1. Preferably, the second calculator K₂ associates the motion parameter D1 with a special effect.

The second setpoint C₂ is associated with a special effect. The special effect is intended to be applied to the first signal S₁ generated by the first calculator

In one embodiment, the special effect is selected from a library of special effects. The system may comprise a memory comprising a library of special effects. The second calculator K₂, then selects a special effect from the library based on the motion parameter D1. The association between a given motion and a special effect can be preconfigured. According to one embodiment, this association is made free for the user from a configuration interface.

In one embodiment, the special effect is selected from the library depending on the type of motion detected. The intensity value of the special effect to be applied can be determined depending on the intensity and/or amplitude of the recognized gesture.

In one embodiment, the second setpoint C₂ comprises several special effects that can be combined, especially when several gestures are recognized simultaneously.

Signal Generator

The system also comprises a signal generator GEN. The signal generator GEN is connected to the first calculator K₁ and the second calculator K₂. The signal generator receives the first setpoint C₁ generated by the first calculator K₁. The signal generator GEN receives the second setpoint C₂ generated by the second calculator K₂.

The signal generator GEN generates a second signal S₂. The second signal S₂ is produced based on the first setpoint C₁ and/or the first signal S₁. The second signal S₂ is also produced based on the second setpoint C₂. Preferably, the second signal S₂ comprises the first signal S₁ to which a special effect extracted from the second setpoint C₂ is applied.

In one embodiment, the signal generator GEN produces a control signal comprising the second signal S₂. Preferably, the signal generator GEN produces a control message, most preferably a MIDI control message. The MIDI control message includes the second sound signal S₂.

Single Case

In one embodiment, the touchpad PT, the optical detection device OPT, the first calculator K₁, the second calculator K₂ and the signal generator are included in a single case.

The single case preferably includes a means for transmitting the second signal S₂. The single case advantageously allows the user to have only one item of equipment to carry. Preferably, the means for transmitting the second signal S₂ is a speaker or an amplifier.

In the latter case, the system of the invention is a musical instrument.

In one embodiment, the single case comprises means for communicating with a second touchpad similar to the touchpad of the present invention. The invention then allows two musicians to play together remotely.

In one embodiment not represented, the system comprises a first case comprising the touchpad PT and a second case comprising the optical detection device OPT and means for communicating between the two cases, for example via an internet network.

The system can then be used by two remote users. When the two cases generate setpoints that can be received, for example, by a musical instrument, the latter can be associated locally with one of the cases or can also be accessible via a data network. Thus according to an example case, a first user manipulates the first case at a first position, the data whose setpoints are then transmitted to the musical instrument via a data network and a second user manipulates the second case at a second position, the data whose setpoints are sent via a data network to the musical instrument. The musical instrument is then capable of synthesizing a note that corresponds to the product of a first setpoint and a second setpoint. A use case can be the production of a sound sequence between different artists during a live event.

Other Fields of Application of the Invention than the Field of Music

The present invention may find application in other fields than the field of music.

In a first alternative embodiment, the present invention is intended to be used in the field of lighting, especially stage lighting.

For example, the system is intended to be connected to a lighting system comprising a plurality of light sources. The first signal S₁ may comprise information of the light source to be activated.

The special effect included in the second setpoint C₂ may include a modulation of the intensity or wavelength emitted by the light source. The second setpoint C₂ may also include a change in the orientation of the light source.

Advantageously, the invention makes it possible to produce a second signal S₂ for controlling a stage lighting device.

In a second alternative embodiment, the present invention is intended to be used in the field of hologram control or the field of video games.

For example, the system is intended to be connected to a device for generating a hologram. The first signal S₁ may comprise information including a shape of a hologram.

The special effect included in the second setpoint C₂ may comprise position information. The second setpoint C₂ then allows the hologram whose shape has been determined by the first signal to be set in motion.

Method for generating a signal According to a second aspect, the invention relates to a method for generating a signal. An embodiment of said method is illustrated in FIG. 4.

The method comprises a step of acquiring ACQ the location and intensity of a user's pressure on a touchpad PT comprising a plurality of touch cells.

The method comprises a step of producing PROD the first setpoint C₁ associated with the production of the first signal S₁.

The method includes a step of acquiring CAPT at least one image by the optics CAM.

In one embodiment, the step of acquiring CAPT at least one image comprises acquiring at least one image comprising at least one part of a user, preferably a hand of the user.

The method includes a step of determining DET at least one motion parameter D1 based on the acquired images.

Image Processing

In one embodiment, the second calculator K₂ comprises software means for implementing a step of processing the images acquired by the optics CAM.

In one simplified embodiment of the invention, the second calculator K₂ allows simple motions and/or simple positions and/or speeds of movement of the hand to be detected. This is the case for simple motions of, for example, an arm moving from left to right or up and down.

In one enriched embodiment of the invention, the second calculator K₂ is configured to detect hand postures, finger motions or complex gestures involving a sequence of linked motions. The enhanced embodiment may also comprise detection according to the simplified mode. The two embodiments may be combined.

According to one embodiment, the image processing results in the generation of an image comprising at least points of interest of the user.

In one embodiment, the optical detection device OPT or the first calculator K₁ comprises a module for processing images IMG₁. The image processing module generates at least one second image IMG₂. The second image IMG₂ includes a shape of at least the points of interest extracted from the first image IMG₁. This can be for example tips of a limb such as the finger tips, joint points, shape contours, etc.

Adaptive Threshold

The generation of the second image IMG₂ follows the step of receiving a captured image IMG₁ by the optical detection device OPT.

The generation of the second image IMG₂ may include a thresholding step. The thresholding step comprises applying one or more filters to the captured image IMG₁.

The filter may include a Laplacian filter. The Laplacian filter is used to sharpen the contours of the user's shapes. The filter may include a filter to decrease the noise of the captured image.

Generating the second image IMG₂ may comprise a step of exploiting a depth map obtained based on the image captured by the optical detection device OPT. The depth map comprises a point cloud for identifying for each pixel, or for each group of pixels, a value associated with the depth. The second image IMG₂ can then advantageously be a 3D image.

Detection of Regions of Interest

According to one embodiment, the generation of the second image IMG₂ comprises an enhancement of the representation of regions of interest.

The detection of regions of interest is performed based on the images captured by the optics CAM, possibly the images generated by the thresholding step and/or by the step of creating a depth map. The detection of regions of interest comprising labeling each pixel or group of pixels.

In the example of the user's hand shown in FIG. 10, the regions of interest may include the palm 53, the wrist 54, the first phalanges of each finger 52 (thumb, index finger, middle finger, ring finger, little finger), and the tip and/or last phalange 51 of each finger. In one embodiment not represented, the regions of interest may include each phalange of the fingers of the hand.

In one embodiment, the detection of the regions of interest is implemented by a classifier following the implementation of an artificial intelligence algorithm for example configured based on a neural network. The classifier is a classifier for example previously trained by means of a set of hand images. The image database may comprise a database of hand images on which regions of interest have been manually annotated.

In one alternative embodiment, the image database is generated from a parametric model to generate a large number of hand images comprising different positions or poses. The parametric model generates images in which regions of interest are already labeled.

The step of detecting regions of interest generates a labeled image of the user as output. Each pixel of the labeled image corresponding to the user is associated with a label corresponding to a region of interest.

Generation of the Points of Interest

Generating the second image IMG₂ further comprises a step of generating points of interest. The points of interest may be generated based on the labeled image comprising the areas of interest.

The points of interest may include centers of mass 103. The centers of mass 103 may be generated at coordinates substantially corresponding to the center of an area of interest. For example, a point of interest may correspond to the center of mass of the palm of the hand.

The points of interest may comprise deflection points 102. Deflection points 102 are generated at the boundary between two adjacent areas of interest. For example, a point of interest may be generated between areas of interest corresponding to two adjacent phalanges of the same finger. The location of such a point of interest can then correspond to the location of a joint, for example between two phalanges. Preferably, generating a point of interest may comprise creating a point of interest substantially in the middle of a segment formed by the boundary between two adjacent areas of interest.

Points of interest may include the tip or end of a finger 101. Such a point of interest may be generated at the distal end of the region of interest corresponding to the last phalange of a finger, or corresponding to a center of mass of the region of interest corresponding to the last phalange of a finger.

In one embodiment, the step of generating the points of interest 103, 102, 101 comprises generating at least one point of interest per region of interest.

In one embodiment, the step of generating the points of interest comprises generating depth coordinates of each point of interest.

The step of generating the points of interest outputs an image or depth map comprising the points of interest extracted from the image generated by the step of detecting areas of interest.

Generation of a Skeleton

In one embodiment, generating the second image IMG2 may include a step of generating a skeleton. The skeleton is generated by connecting together points of interest in a predetermined manner.

FIG. 11 illustrates a skeleton 104 obtained by connecting certain points of interest 102, 101. For example, the points of interest corresponding to the joints 102 of the same finger are connected together.

The step of generating a skeleton outputs an image IMG₂ or a depth map IMG₂ comprising the points of interest and a skeleton connecting the points of interest together so as to reproduce the shape of the user.

Advantageously, the step of generating a skeleton allows a hand model to be mapped onto the points of interest.

The second image IMG₂ may comprise the image and/or depth map generated by the step of generating the points of interest and/or the step of generating a skeleton.

The skeleton may comprise segments connecting certain points of interest together.

Motion Parameter

In one embodiment, determining a motion parameter D1 comprises detecting at least one type of motion of a user based on the captured images.

Preferably, detecting a type of motion of a user comprises detecting a motion of a user's hand. Detecting a motion is performed based on the images captured by the optical detection device OPT.

By “based on the captured images”, it is included herein the raw images as captured by the optics CAM as well as the images generated by the processing of these images, for example the images IMG₂ generated from the generation of the point of interest. Also included are any two-dimensional images or any depth maps.

Preferably, the different types of motion are listed in a library. The calculator can then perform a fitting operation or an analytical regression operation to determine a particular type of motion based on the captured images.

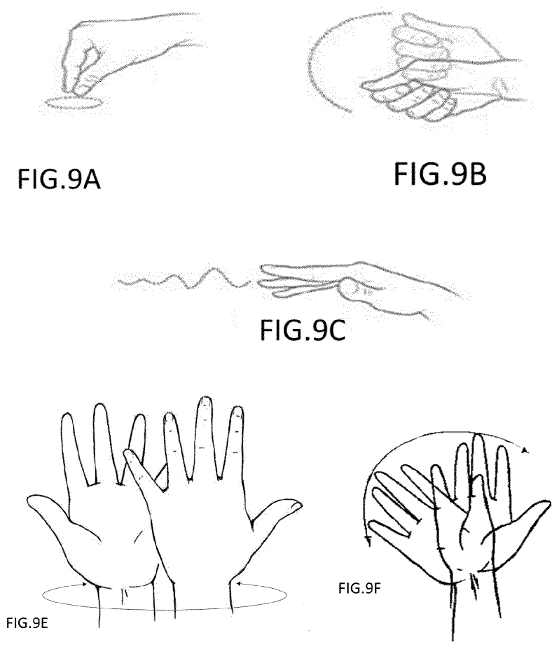

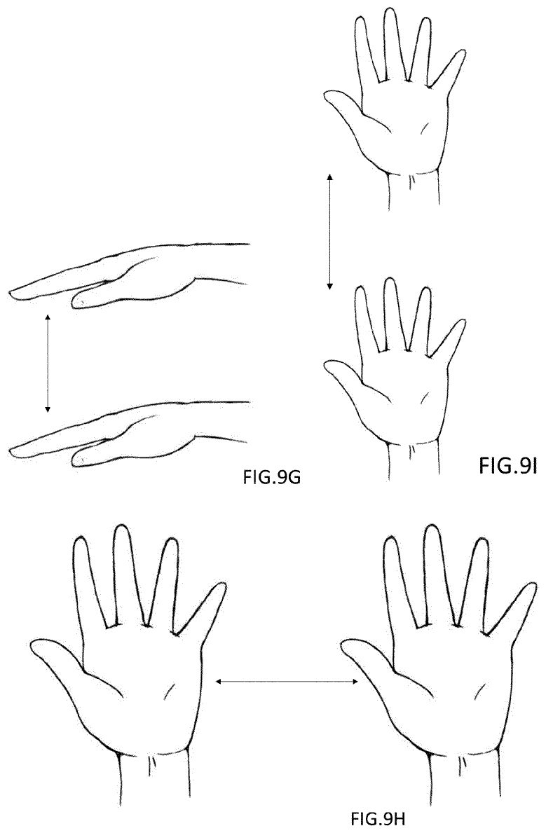

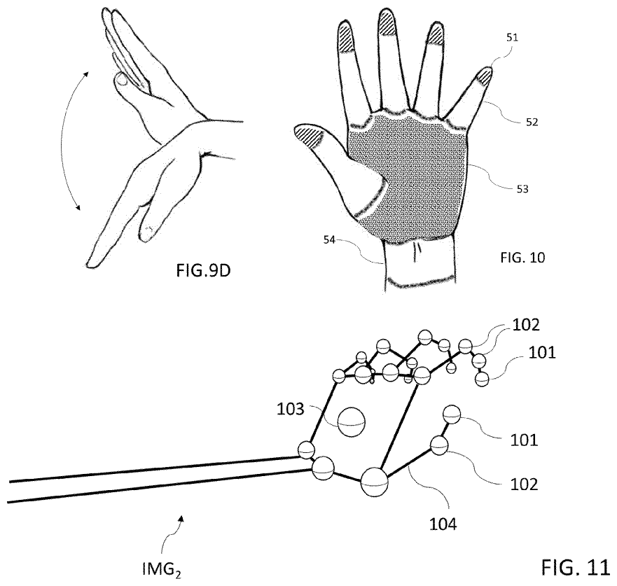

FIGS. 9A to 9I illustrate examples of types of motions of the hand. These types of motions are recognizable by the second calculator K₂. The second calculator K₂ generates a motion parameter D1 based on the detected type of motion.

Examples of types of motion of the hand may comprise a rotational motion of the wrist with closed fist (FIG. 9B), a rotation of the hand along a longitudinal axis of the forearm (FIG. 9E), along an axis perpendicular to the longitudinal axis of the forearm (FIGS. 9D and 9F). Another example of a type of motion may comprise a transverse movement of the hand (FIGS. 9I, 9H, and 9G).

The type of motion may also depend on the position and/or motion of the finger joints. For example, the type of motion may be different if the wrist rotation gesture is performed with the hand open or closed. Certain types of motions may be associated with personalities' known gestures in the musical or audiovisual world. For example, a type of downward hand closing motion executed at a speed beyond a threshold while simultaneously tightening the fingers may be characteristic of a “hand closing according to Ardisson”. According to another example, a simultaneous closing of the hand and a transverse motion of the elbow may be characteristic of a hand closing motion according to the host Nagui. Another example of a type of motion illustrated in FIG. 9A may include a closing of the fingers of the hand with the fingers extended. Another example of the type of motion may include a wobble of the hand in a manner that mimics the motion of a wave, as represented in FIG. 9C.

The type of motion may also be a function of the direction of the gesture. For example, a translational hand movement gesture may be discriminated depending on the plane and/or direction of translation. For example, in FIG. 9G, the translation is performed along the axis perpendicular to the palm of the hand. FIGS. 9H and 9G illustrate a translation motion of the hand in the same plane with one motion in the direction perpendicular to the longitudinal direction of the fingers (FIG. 9H) and the other in a direction parallel to the longitudinal direction of the fingers (FIG. 9I). In another example, a wrist rotation can be detected in the plane.

Preferably, the motion parameter D₁ also includes determining the speed and/or amplitude of the motion.

Second Setpoint

The method comprises a step of generating GEN_{C2} the second setpoint C₂ based on the motion parameter D1. The second setpoint C₂ is associated with a special effect.

Special Sound Effects

In the embodiment where the first signal S₁ is a sound signal, the special effect is a special effect of altering the sound signal.

The special effect can be selected from one or more of the following special effects:
▪A signal reverberation: effect obtained by creating repeated sounds based on the first sound signal, with a delay not exceeding 60 ms, so that the brain cannot distinguish each sound separately.
An echo: effect achieved by repeating the first sound signal with a delay time long enough for the human brain to perceive the two sounds separately.
A distortion: effect achieved by amplifying the first sound signal strongly in order to clip it or flatten it.
Sustain: effect achieved by maintaining the first sound signal in time after having triggered it.
A wha-wha: effect achieved by passing the first sound signal through a bandpass filter.
A vibrato: effect achieved by modulating the frequency of the first sound signal around its original value.
▪A tremolo: effect achieved by modulating the amplitude (and therefore the volume) of the first sound signal.

The special effect can be selected from a library that can also include phase shifting of the sound signal, frequency transposition of the sound signal, modification of the timbre, filtering of the sound signal, stopping of the sound signal.

In one embodiment, the special effect is selected from a modulation of the signal intensity. The intensity of the signal S₂ can thus be controlled firstly by the intensity of the pressure exerted on the touchpad PT and/or by a gesture of the user sensed by the optical detection device OPT.

Second Signal

The method comprises a step of generating GEN_{S2} the second signal S₂ based on the first setpoint C₁ or the first signal S₁ and based on the second setpoint C₂.

In one embodiment, the method comprises a step of applying the special effect to the first signal S₁. The application consists, for example, in a modulation, a mix, or even more generally a combination of signals that can be of any type. According to one example, the effect is applied to a portion only of the first signal. According to another example, the effect is produced over a given period of time and is applied to all first signals produced in this period of time.

Transmission of the Second Signal S₂

In one embodiment, the method comprises generating and transmitting the second signal S₂. The second signal S₂ is preferably transmitted to a device capable of applying the signal such as a control device or a sound device. This may be a speaker, a loudspeaker or more generally any type of membrane capable of making the second signal S₂ audible.

Preferably, generating the second signal is preceded by a step of generating a third setpoint, the third setpoint being associated with the second signal. The method and the system are then advantageously capable of transmitting the generated second signal, for example in the form of a MIDI message.

Alternative

Alternatively, the first setpoint generated based on the location and intensity of the pressure on the touchpad is associated with a special effect. The second setpoint generated based on the motion parameter is associated with the production of a first signal.

The second signal is then generated based on the second setpoint (or the first signal) to which a special effect extracted from the first setpoint is applied.

This alternative allows, for example, the user to generate a first signal associated with a note using the optical detection device and apply a special effect to said first signal, the special effect being selected based on the location and/or intensity of pressure on the touchpad.

1. A system for generating a signal comprising:
a touchpad comprising a plurality of touch cells and a touch detection device for detecting the location and intensity of at least one pressure exerted on said touchpad;
an optical detection device for detecting a motion of a hand a position comprising at least one optics for capturing images;
a first calculator configured to generate at least one first setpoint based on the location and the intensity of said at least one pressure,
a second calculator for determining at least one motion parameter based on the rotational motion of the wrist or of at least one finger and/or on the direction of translation of a translational hand or finger movement gesture based on the captured images by the optical detection device and for generating a second setpoint based on said at least one motion parameter; and
a signal generator for producing a second signal based on:
the first setpoint or a first signal extracted from the first setpoint to which a special effect extracted from the second setpoint is applied; or
the second setpoint or a first signal extracted from the second setpoint to which a special effect extracted from the first setpoint is applied.

2. The system according to claim 1, wherein the first signal and the second signal are sound signals.

3. The system according to claim 2, wherein the signal generator is configured to produce the second signal as a third setpoint.

4. The system according to claim 1, wherein each touch cell CT comprises:
a first layer comprising at least one force sensing resistor; and
a second layer comprising a detection cell adapted to detect a variation in the resistivity of the force sensing resistor.

5. The system according to claim 4, wherein each detection cell comprises a printed circuit comprising at least a first portion and a second portion connected to each other through the force sensing resistor of the first layer.

6. The system according to claim 1, wherein the motion parameter is determined based on an amplitude, speed of the hand and/or direction of a finger of the hand.

7. The system according to claim 1, wherein the optical detection device for detecting a motion of a hand comprises a stereo camera.

8. The system according to claim 1, further comprising a user interface for providing the second calculator with a feedback data and wherein the second calculator comprises a reinforcement learning algorithm, configured to modify a mode of generation of the second setpoint depending on the feedback data by iteration.

9. The system according to claim 1, wherein said system is a musical instrument and wherein the touchpad and the optical detection device are integrated into a single case.

10. The system according to claim 1, wherein each touch cell comprises a lighting source for producing a light signal when a pressure is exerted on said touch cell.

11. A method for generating a signal comprising:
acquiring a location and intensity of a pressure on a touchpad having a plurality of touch cells;
producing a first setpoint EGO based on the acquired location and intensity;
acquiring at least one image by at least one optics;
determining at least one motion parameter comprising the detection of a rotational motion of the wrist or of at least one finger and/or on the direction of translation of a translational hand or finger movement gesture based on the acquired at least one image;
generating a second setpoint based on the motion parameter;
generating a second signal based on:
the first setpoint or a first signal associated with the first setpoint to which a special effect extracted from the second setpoint is applied; or
the second setpoint or a first signal associated with the second setpoint to which a special effect extracted from the first setpoint is applied.

12. The method according to claim 11, wherein the motion parameter is also determined based on an amplitude, speed and/or direction of a hand and/or a finger of the hand.

13. The method according to claim 11, wherein the first sound signal corresponds to a musical note.

14. The method according to claim 11, wherein determining at least one motion parameter EDI comprises detecting points of interest.

15. The method according to claim 11, wherein determining at least one motion parameter based on the acquired images comprises generating a depth map, said motion parameter being determined also depending on said depth map.

16. The method according to claim 11, wherein said special effect comprises one or more of the elements listed below:
a reverberation,
an echo,
a distortion,
a sustain,
a wha-wha,
a vibrato,
a phase shift.

17. (canceled)

18. A non-transitory computer-readable data storage medium having recorded thereon a computer program comprising program code instructions for implementing the method of claim 11.

19. The system according to claim 7, wherein the stereo camera is an infrared stereo camera.

20. The method according to claim 14, wherein the point of interests are finger tips, the center of mass and/or a deflection point.
